(19) United States
(12) Patent Application Publication
(10) Pub. No.: US 2010/0264722 A1
(43) Pub. Date: Oct. 21, 2010

(54) BICYCLE RIM WITH MECHANICAL SPOKE ATTACHMENT

(76) Inventor: Charles R. Teixeira, IV, Canyon Country, CA (US)

Correspondence Address: PERKINS COIE LLP, POST OFFICE BOX 1208, SEATTLE, WA, 98111-1208, US

(21) Appl. No.: 12/426,127

(22) Filed: Apr. 17, 2009

(51) Int. Cl. B60B 21/06; B21D 53/26

(52) U.S. Cl. 301/58; 29/894.333

(57) ABSTRACT

A bicycle wheel includes a central hub and a rim including multiple openings positioned about the circumference of a radially inner surface of the rim. A rivet nut or similar attachment element is positioned in each opening and coupled to the rim. A first end of a nipple or similar coupling element is threaded into or otherwise attached to each rivet nut. A first end of a spoke is threaded into or otherwise attached to a second end of each nipple. A second end of the spoke is coupled to or engaged with the central hub.

Each nipple optionally includes left-hand external threads and right-hand internal threads, or right-hand external threads and left-hand internal threads, such that rotation of the nipple simultaneously tightens or loosens the nipple with respect to both the rivet nut and the spoke.

### BACKGROUND

Many bicycle wheels include metal rims having a radially outer bridge to which a tire may be attached and a radially inner bridge to which metal spokes are attached. The spokes are typically threaded into nipples which are threaded into drilled holes in the radially inner and outer bridges. In designs where the spokes do not penetrate the radially outer bridge, such as in designs in which the spokes are brazed onto the radially inner bridge, the tire attached to the radially outer bridge may be tubeless, i.e., the tire would not require an inflatable inner tube.

Tubeless tires are desirable to many bicycle riders for several reasons, including that they perform well at lower air pressures than similar tires having inner tubes. A tire with lower air pressure generally provides better traction and a degree of suspension to the bicycle. While metal rims that accommodate tubeless tires have generally been effective, tubeless systems have not been effectively employed using composite rims. Due to the fibrous nature of composite rims, nipples cannot effectively be threaded or spun into the rims. Additionally, metal spokes cannot be brazed onto a composite rim.

Some relatively complicated mechanical spoke attachment systems, which do not require threading or brazing, have been proposed for attaching spokes to bicycle rims. In one such system, an internally threaded, spring-loaded coupler is secured to the radially inner rim bridge by forcing the coupler through an opening in the radially inner bridge such that the coupler snaps into place. A fastener in which a spoke is secured via a floating lock nut is then threaded into the coupler. While such a system allows the spoke to be mechanically attached to the rim, the spoke and lock nut are free to float and rotate within the fastener, which can lead to spoke misalignment or de-tensioning.

Furthermore, in such a design, the spoke must be positioned in the fastener and threaded into the lock nut before the fastener is threaded into the coupler. The presence of the spoke in the fastener, however, can make it difficult to tighten and loosen the fastener within the coupler. As a result, attaching spokes in general, and replacing a broken spoke in particular, can be a difficult and inefficient process. Furthermore, if a spoke breaks in such a system, the radially outer end of the spoke and the attached lock nut my fall inside the rim and be very difficult to extract from the rim.

### SUMMARY

A bicycle wheel includes a central hub and a rim including multiple openings positioned about the circumference of a radially inner surface of the rim. A rivet nut or similar attachment element is positioned in each opening and coupled to the rim. A first end of a nipple or similar coupling element is threaded into or otherwise attached to each rivet nut. A first end of a spoke is threaded into or otherwise attached to a second end of each nipple. A second end of the spoke is coupled to or engaged with the central hub.

Each nipple optionally includes left-hand external threads and right-hand internal threads, or right-hand external threads and left-hand internal threads, such that rotation of the nipple simultaneously tightens or loosens the nipple with respect to both the rivet nut and the spoke.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the views:

FIG. 1 is a perspective view of a bicycle wheel including a rim with mechanically attached spokes, according to one embodiment.

FIG. 2 is an exploded view of a rim section and corresponding spoke attachment elements of the bicycle wheel shown in FIG. 1.

FIG. 3 is a partially exploded view of the rim section and corresponding spoke attachment elements shown in FIG. 2 with the rivet nut coupled to the rim.

FIG. 4 is a sectional view of a rim section including the spoke attachment elements shown in FIGS. 2 and 3 in a fully assembled configuration.

FIG. 5 is a sectional view of a counterbored rim section including the spoke attachment elements shown in FIGS. 2 and 3 in a fully assembled configuration.

FIG. 6 is a sectional view of a rim section including the spoke attachment elements shown in FIGS. 2 and 3, in combination with a curved nipple bed, in a fully assembled configuration.

FIG. 7 is a sectional view of a rim section including a rivet nut into which a spoke is directly threaded.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below. Any terminology intended to be interpreted in any restricted manner, however, will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

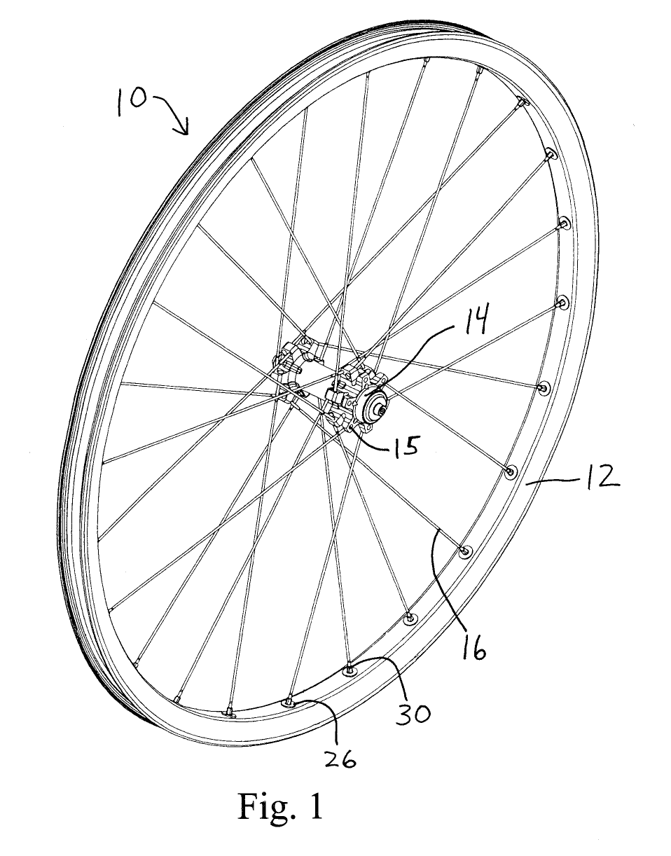

Turning now in detail to the drawings, as shown in FIG. 1, a bicycle wheel 10 according to one embodiment includes a rim 12 and a central hub 14. Spokes 16 are secured between the rim 12 and the central hub 14. Radially inner ends of the spokes 16 are coupled to or engaged with fingers 15, hub spoke holes, or other attachment elements on the central hub 14, while radially outer ends of the spokes 16 are secured to the rim 12 via the attachment mechanisms described below.

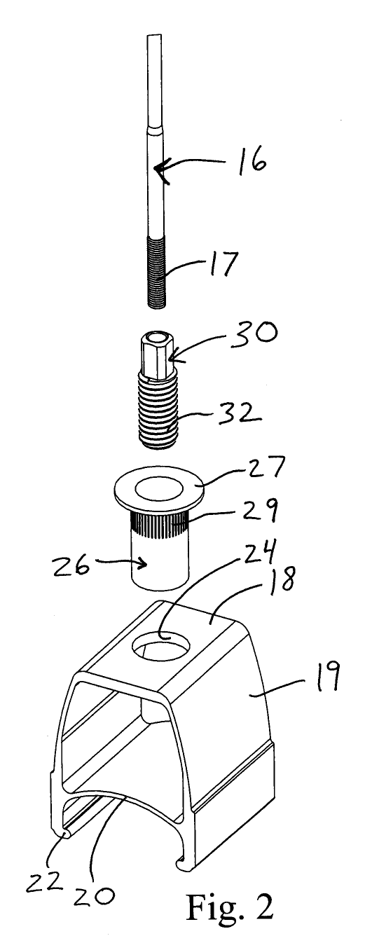

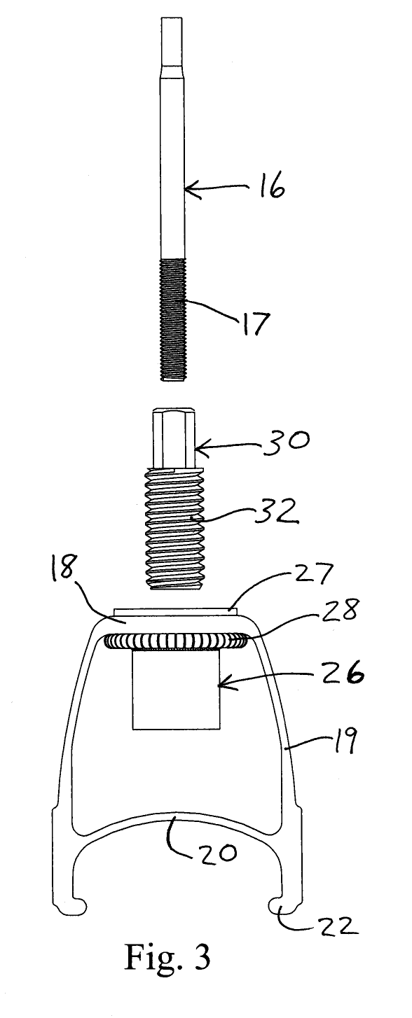

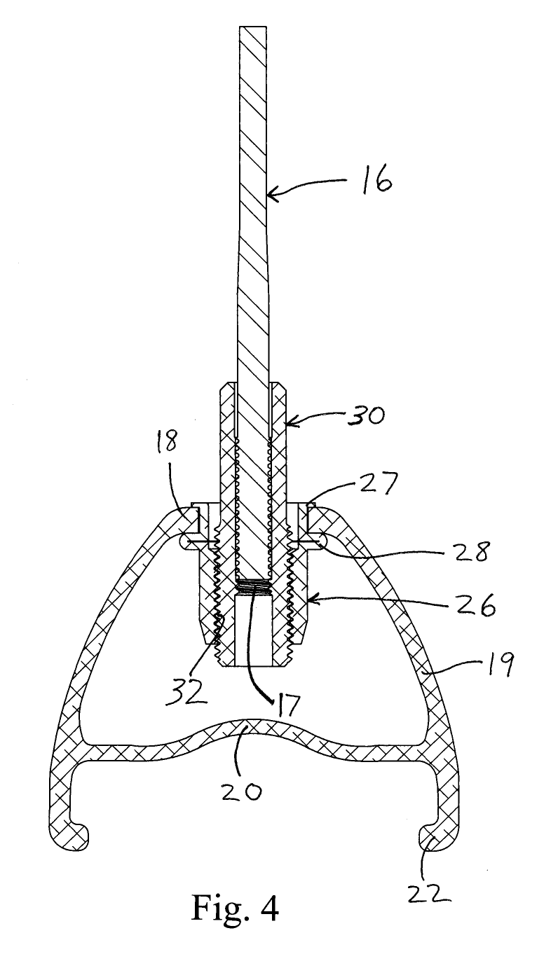

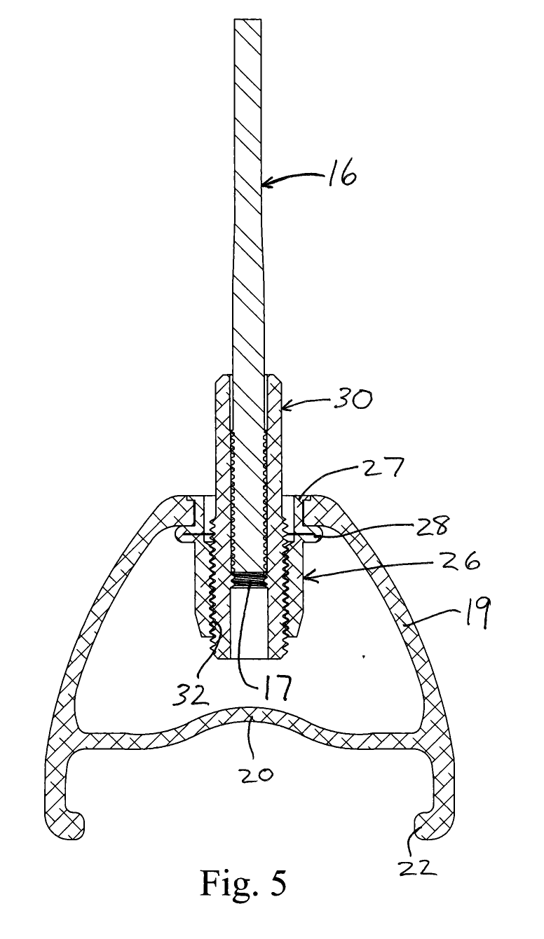

As shown in FIGS. 2 and 3, the bicycle rim 12 includes a radially inner bridge 18 and a radially outer bridge 20 including flanges 22 for securing a bicycle tire to the rim 12. The radially inner bridge 18 is connected to the radial outer bridge 20 via side walls 19. The radially inner bridge 18 includes multiple openings 24 that may be evenly or unevenly spaced about its circumference. A rivet nut 26 or similar attachment element is positioned in each opening 24. Each rivet nut 26 includes an upper flange 27 that rests or seats on the radially inner surface of the radially inner bridge 18, as shown in FIG. 4. Alternatively, as shown in FIG. 5, portions of the radially inner bridge 18 about the openings 24 may be counter-bored so that the radially inner surface of the upper flange 27 is flush with the radially inner surface of the radially inner bridge 18.

As shown in FIGS. 3-7, the rivet nut 26 preferably includes an expansion portion 28 that may be outwardly expanded with a suitable tool after the expansion portion 28 passes through the opening 24. In this manner, the expansion portion 28 engages the radially outer surface of the radially inner bridge 18 so that the rivet nut 26 is coupled to the radially inner bridge 18. The rivet nut 26 may alternatively include any other suitable element or mechanism for securing the rivet nut 26 to the radially inner bridge 18. As shown in FIG. 2, the rivet nut 26 optionally further includes external knurls, teeth 29, or other friction elements that prevent, or substantially prevent, the rivet nut 26 from rotating within the opening 24. In one embodiment, the rivet nuts 26 may be angled relative to the rim openings 24 such that they are “targeted” or aligned with their corresponding hub fingers 15 or other connection elements on the central hub 14.

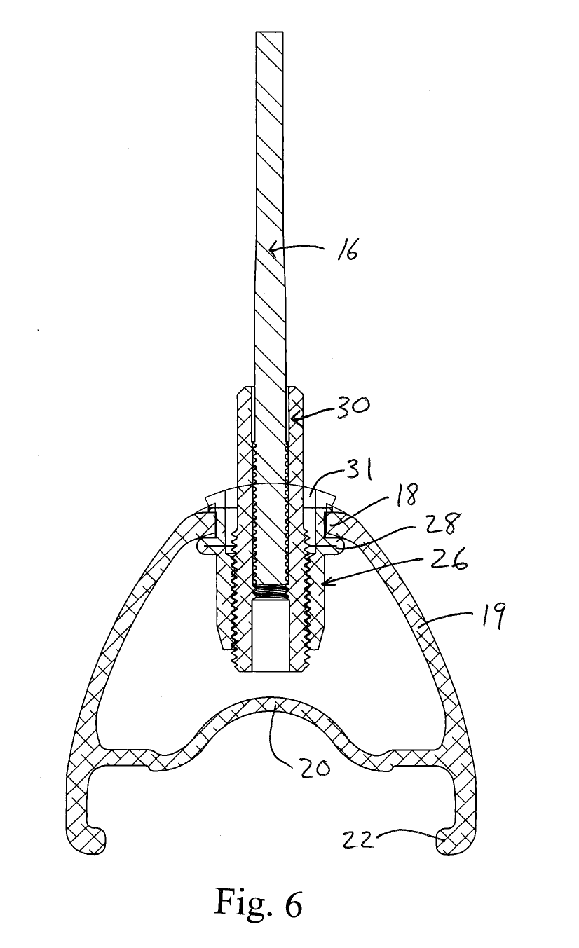

The rivet nut 26 preferably includes a threaded inner region. A hollow nipple 30 or similar coupling element including external threads 32 is threaded into the inner region of the rivet nut 26, as shown in FIGS. 4-6. The nipple 30 preferably also includes internal threads for receiving external threads 17 of a spoke 16. Thus, the nipple 30 may be threaded directly into the rivet nut 26, and the spoke 16 may be threaded directly into the nipple 30. in one embodiment, as shown in FIG. 6, a curved nipple bed 31 may be included for receiving the nipple 30.

In one embodiment, the internal threads of the rivet nut 26 and the external threads 32 of the nipple 30 are “left-hand” threads, while the internal threads of the nipple 30 and the external threads 17 of the spoke 16 are “right-hand” threads. Alternatively, the internal threads of the rivet nut 26 and the external threads 32 of the nipple 30 may be “right-hand” threads, while the internal threads of the nipple 30 and the external threads 17 of the spoke 16 may be “left-hand” threads. Accordingly, the tension in the spoke 16 can be adjusted by turning only the nipple 30, which causes simultaneous tightening or loosening of the nipple 30 relative to both the spoke 16 and the rivet nut 26.

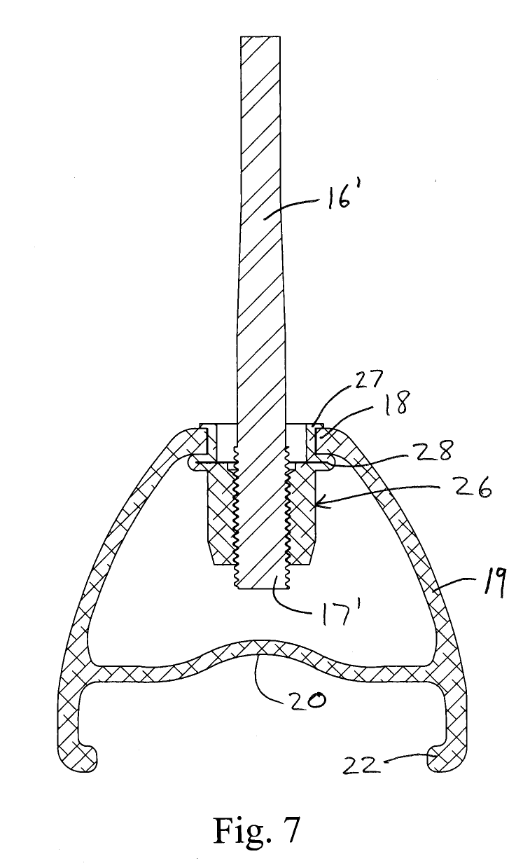

In an alternative embodiment, as shown in FIG. 7, the nipple 30 may be omitted and a spoke 16′ having an enlarged threaded head 17′ may be threaded directly into the rivet nut 26. Alternatively, a spoke with a regular threaded head may be threaded into a rivet nut having a threaded inner region with a smaller internal diameter. In another embodiment, the spoke may have a moderately enlarged threaded head, and the rivet nut may have a threaded inner region with a moderately smaller internal diameter, such that the spoke may be threaded directly into the rivet nut.

To assemble the wheel 10, according to an embodiment in which nipples 30 are used, openings 24 are drilled or otherwise formed in the radially inner bridge 18 of the rim 12, which may be extruded or otherwise formed. A rivet nut 26 or similar attachment element is then positioned in each opening 24 and squeezed or manipulated with a suitable tool to cause the expansion portion 28 of the rivet nut 26 to expand and couple the rivet nut 26 to the radially inner bridge 18. The spokes 16 are then guided through hub spoke holes or openings in the hub fingers 15, or otherwise connected to the hub 14. In one embodiment, each spoke 16 includes a head on its radially inner end having a larger diameter than that of the hub spoke hole or opening in the hub finger 15 so that the spoke 16 does not pass all the way through the hole or opening.

Each nipple 30 or similar coupling element is then loosely threaded (one or more turns) onto the external threads 17 of a spoke 16, after which the external threads 32 on the nipple 30 are loosely threaded into the inner threads of a corresponding rivet nut 26. Once all of the spokes 16 are loosely attached, the nipples 30 may be turned to tighten the spokes 16 to a desired tension. If the “left-hand/right-hand” nipple configuration described above is employed, turning of a nipple 30 simultaneously tightens or loosens the nipple 30 relative to both the spoke 16 and the rivet nut 26 to which it is threaded. The nipples 30 are preferably progressively tightened while wheel run-out is measured using a suitable measuring device. In this manner, the number of turns of each of the nipples 30 may be adjusted until a round wheel 10 with even tension is achieved. In an alternative embodiment, the nipples 30 may first be threaded to a desired depth in the rivet nuts 26, after which the nipples 30 may be securely held while the spokes 16 are turned by hand or with spoke-gripping pliers to tighten the spokes 16 relative to the nipples 30.

The various components of the bicycle wheel 10 may be made of any suitable materials. For example, the rivet nuts 26 and nipples 30 may be made of aluminum, brass, steel, a composite material, or any other suitable material. The spokes 16 may be made of steel, titanium, aluminum, carbon, or any other suitable material. The hub 14 may be made of aluminum, magnesium, a composite material, or any other suitable material. The rim 12 may optionally be made of aluminum or another suitable metal. Because the rivet nuts 26 are positioned in and coupled to the radially inner bridge 18 without being threaded or spun into the radially inner bridge 18, however, the rim may alternatively be made of a composite material, such as carbon, fiberglass, aramid, Kevlar®, or another suitable composite material. Many bicycle riders prefer composite rims due to their weight, feel, or appearance.

The beads of a bicycle tire may be positioned within the flanges 22 of the radially outer bridge 20, after which the tire may be inflated to secure and seal the tire to the rim. Because the radially outer bridge 20 is not penetrated by the spokes 16 and preferably does not include any openings, a tubeless tire, which is preferred by many bicycle riders, may optionally be used. Thus, a bicycle wheel including a composite rim attached to a tubeless tire, which was previously difficult and inefficient to achieve, may be efficiently constructed.

Some advantages of the bicycle wheel 10 described herein include the following: a tubeless tire may be efficiently and effectively used on a composite rim; the spokes are directly threaded into the nipples or other coupling elements, which makes them easily replaceable and prevents them from falling into the rim if they break; lock nuts are not required to secure the spokes to the rim; the spokes are self-aligning due to their direct threading into the nipples (as opposed to being threaded into a separate, floating lock nut), which also prevents the spokes from floating within the nipple; the optional “left-hand/right-hand” nipple configuration allows for simultaneous tightening or loosening of the nipple relative to both the spoke and the rivet nut or other attachment element; the optional teeth or friction elements on the rivet nuts prevent, or substantially prevent, the rivet nuts from rotating within the openings in the radially inner bridge, thus maintaining proper spoke alignment.

Any of the above-described embodiments may be used alone or in combination with one another. Furthermore, the bicycle wheel or rim may include additional features not described herein. While several embodiments have been shown and described, various changes and substitutions may of course be made, without departing from the spirit and scope of the invention. For example, the steps of assembling the bicycle wheel may be performed in a different order than that which is explicitly described. The invention, therefore, should not be limited, except by the following claims and their equivalents.

What is claimed is:

1. A bicycle wheel, comprising:
a central hub;
a rim including a plurality of openings;
a rivet nut positioned in each of the openings and coupled to the rim, wherein each rivet nut includes internal threads, and for each rivet nut the bicycle wheel further comprises;
a nipple including external threads threaded into the internal threads of the rivet nut, wherein the nipple further includes internal threads;
a spoke including a first end having external threads threaded into the internal threads of the nipple, wherein the spoke includes a second end coupled to or engaged with the central hub; and
wherein the external threads of the nipple comprise one of left-hand threads and right-hand threads, and the internal threads of the nipple comprise the other of left-hand threads and right-hand threads, such that rotation of the nipple in one direction simultaneously tightens the nipple relative to both the rivet nut and the spoke, and rotation of the nipple in the opposite direction simultaneously loosens the nipple relative to both the rivet nut and the spoke.

2. The bicycle wheel of claim 1 wherein the rim comprises a composite material.

3. The bicycle wheel of claim 1 wherein each of the rivet nuts includes a flange and an expansion portion between which a portion of the radially inner bridge is located.

4. The bicycle wheel of claim 3 wherein regions about the openings in the rim are counterbored such that a radially inner surface of the flange is flush with a radially inner surface of the rim.

5. The bicycle wheel of claim 1 wherein each of the rivet nuts includes external teeth engaging the rim about the opening in which the rivet nut is positioned to prevent, or substantially prevent, the rivet nut from rotating within the opening.

6. The bicycle wheel of claim 1 wherein the rim comprises a radially inner bridge and a radially outer bridge including flanges configured to secure a bicycle tire to the radially outer bridge.

7. The bicycle rim of claim 6 wherein the openings are formed in the radially inner bridge, and wherein the radially outer bridge is devoid of openings such that it is compatible with a tubeless tire.

8. A bicycle wheel, comprising:
a central hub;
a rim comprising a radially inner bridge and a radially outer bridge, wherein the radially inner bridge includes a plurality of openings and the radially outer bridge is devoid of openings such that it is compatible with a tubeless tire;
an attachment element positioned in each of the openings and coupled to the rim;
a coupling element engaged with each of the attachment elements; and
a spoke engaged with each of the coupling elements, wherein each spoke has a first end coupled to or engaged with the central hub, and a second end directly engaged with one of the coupling elements such that the second end of the spoke is prevented from floating within the coupling element.

9. The bicycle wheel of claim 8 wherein either:
(a) each of the attachment elements includes internal left-hand threads and each of the coupling elements includes external left-hand threads threaded into the internal left-hand threads, and wherein each of the coupling elements includes internal right-hand threads and each of the spokes includes external right-hand threads threaded into the internal right-hand threads, or
(b) each of the attachment elements includes internal right-hand threads and each of the coupling elements includes external right-hand threads threaded into the internal right-hand threads, and wherein each of the coupling elements includes internal left-hand threads and each of the spokes includes external left-hand threads threaded into the internal left-hand threads;
such that rotation of the coupling element simultaneously tightens or loosens the coupling element relative to both the attachment element and the spoke.

10. The bicycle wheel of claim 8 wherein the rim comprises a composite material.

11. The bicycle wheel of claim 8 wherein each of the attachment elements includes a flange and an expansion portion between which a portion of the radially inner bridge is located.

12. The bicycle wheel of claim 11 wherein regions about the openings in the radially inner bridge are counterbored such that a radially inner surface of the flange is flush with a radially inner surface of the radially inner bridge.

13. The bicycle wheel of claim 8 wherein each of the attachment elements includes external teeth engaging the rim about the opening in which the attachment element is positioned to prevent, or substantially prevent, the attachment element from rotating within the opening.

14. The bicycle wheel of claim 8 wherein the radially outer bridge includes flanges configured to secure a bicycle tire to the radially outer bridge.

15. A bicycle wheel, comprising:
a central hub;
a composite rim comprising a radially inner bridge and a radially outer bridge, wherein the radially inner bridge includes a plurality of openings and the radially outer bridge is devoid of openings such that it is compatible with a tubeless tire;
an attachment element positioned in each of the openings and coupled to the rim;
a coupling element threaded into each of the attachment elements;
a spoke threaded into each of the coupling elements.

16. The bicycle wheel of claim 15 wherein each of the attachment elements includes external friction elements engaging the rim about the opening in which the attachment element is positioned to prevent, or substantially prevent, the attachment element from rotating within the opening.

17. The bicycle wheel of claim 15 wherein each spoke has a first end coupled to or engaged with the central hub, and a second end directly threaded into one of the coupling elements;
wherein each of the coupling elements includes either:
external left-hand threads threaded into one of the attachment elements and internal right-hand threads into which one of the spokes is threaded; or
external right-hand threads threaded into one of the attachment elements and internal left-hand threads into which one of the spoke is threaded.

18. A method of assembling a bicycle wheel, comprising:
providing a rim including a plurality of openings in a radially inner surface of the rim;
positioning an attachment element in each of the openings;
coupling each of the attachment elements to the rim;
wherein, with respect to each of the attachment elements, the method further comprises;
loosely threading a first end of a coupling element onto a first end of a spoke;
loosely threading a second end of the coupling element into the attachment element; and
rotating the coupling element to simultaneously tighten the coupling element relative to both the attachment element and the spoke to achieve a desired tension in the spoke.

19. The method of claim 18 wherein the coupling step comprises expanding a portion of each of the attachment elements such that a portion of the rim is engaged between the expanded portion and a flange on the attachment element.

20. The method of claim 18 further comprising:
measuring wheel run-out during the rotating step; and
adjusting the number of rotations of the coupling elements until a round wheel with even tension is achieved.
